(19) United States
(12) Patent Application Publication
(10) Pub. No.: US 2015/0210860 A1
(43) Pub. Date: Jul. 30, 2015

(54) PAINTING WITH MACROMOLECULE ENERGY LAYER

(71) Applicant: CHIEN TANG LIU, NEW TAIPEI CITY (TW)

(72) Inventor: CHIEN TANG LIU, NEW TAIPEI CITY (TW)

(21) Appl. No.: 14/231,731

(22) Filed: Mar. 31, 2014

(30) Foreign Application Priority Data
Jan. 27, 2014 (TW) 103201643

(51) Int. Cl. C09D 1/00; B44F 99/00; D21H 19/06; A47G 1/06

(52) U.S. Cl. CPC C09D 1/00; A47G 1/06; B44F 99/00; D21H 19/06

(57) ABSTRACT

A painting with macromolecule energy layer includes a frame set and a painting set. The frame set consists of a back plate and a first macromolecule energy layer at a front surface of the back plate. The painting set, positioned adjacent to the front surface of the back plate, consists of a main painting, a creation of a specific figure or texture, and a second macromolecule energy layer, provided at a rear surface of the main painting as facing and separated from the first macromolecule energy layer. Thereby the painting of the present invention can improve the air quality within a room and enhance human health with the first and second macromolecule energy layers.

### TECHNICAL FIELD OF THE INVENTION

The present invention is related to a painting, particularly a painting able to improve the environmental quality and benefit the human health.

### DESCRIPTION OF THE PRIOR ART

A painting is a creation by an artist using the materials such as pigments, paints and dyes on a surface of a specific substance in a combination of means like figures, colors, compositions and lines in order to show an artistic sensation for people in terms of visual impression and spiritual refinement. For the current artistic practice, a painting is usually put on a frame through a backing process in order to enhance the sense of refinement as well as to extend the preservation time of the painting. However, an ordinary painting can be further expanded in the practical applications besides the nature being an artistic creation.

### SUMMARY OF THE INVENTION

An objective of the present invention is to provide a painting with macromolecule energy layer that can improve the air quality within a room and enhance human health.

The painting of the present invention includes a frame set and a painting set. The frame set consists of a back plate and a first macromolecule energy layer provided at a front surface of the back plate. The painting set is positioned adjacent to the front surface of the back plate and consists of a main painting and a second macromolecule energy layer. The main painting is of a specific figure or texture while the second macromolecule energy layer is provided at a rear surface of the main painting as facing and separated from the first macromolecule energy layer.

The main painting is an artistic creation such as a painting on paper, painting on fabric or a ceramic engraving. The first and second macromolecule energy layers include a combination of substances having compositions of negative ion energy powders, far infrared ceramic powders, activated carbon powders, particles with titanium element and germanium element, nano silver particles and titanium-oxide particles.

In a preferred embodiment, the frame set further includes a frame positioned at a circumference of the back plate and a decorating edge positioned at a circumference of the main painting.

In addition, the painting of the present invention includes at least a spacer that is securely provided between the frame set and the painting set in order to keep a distance between the frame set and the painting set. When multiply spacers are used, they are symmetrically and evenly distributed between the frame set and the painting set in order to facilitate the air circulation within a room as well as emit macromolecule energy.

### BRIEF DESCRIPTION OF THE DRAWINGS

FIG. 1 is a perspective diagram of a preferred embodiment of the present invention.

FIG. 2 is a component disassembly diagram of FIG. 1 of the present invention.

FIG. 3 is a cross-section diagram along direction of FIG. 1 of the present invention.

### DETAILED DESCRIPTION OF THE PREFERRED EMBODIMENTS

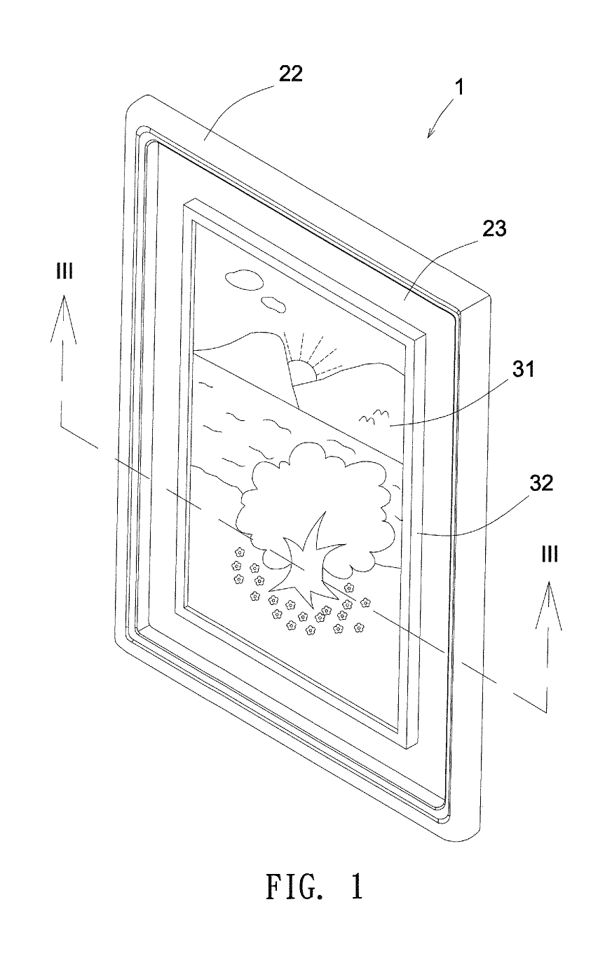

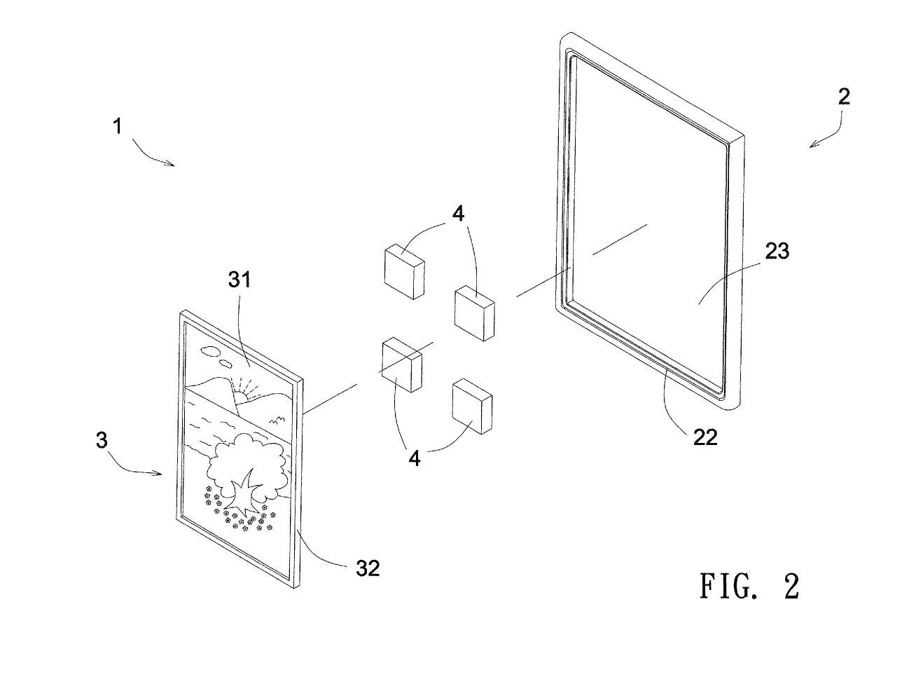

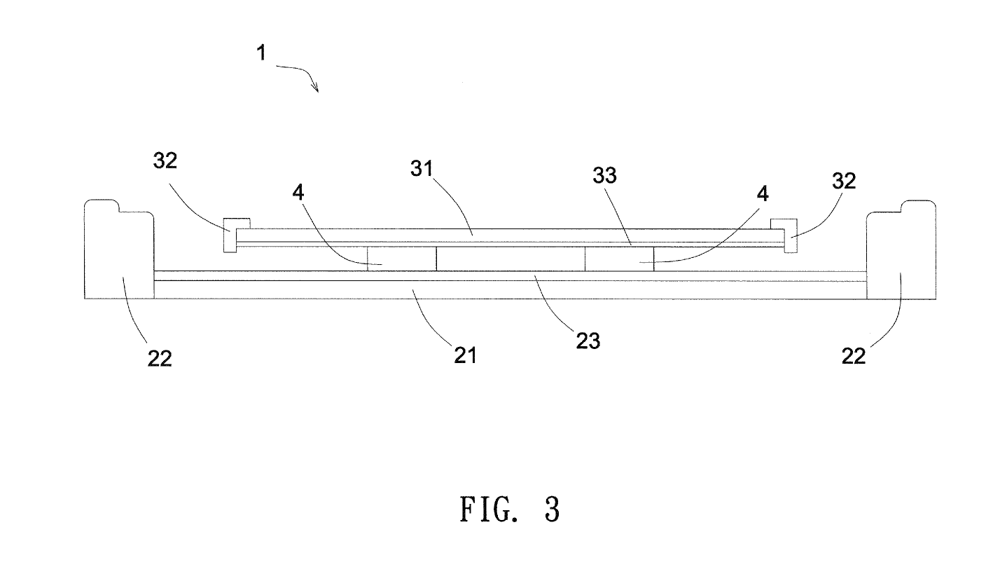

Please refer FIG. 1 through FIG. 3 illustrating a preferred embodiment of the present invention, a painting 1 with macromolecule energy layer that includes a frame set 2, a painting set 3 and at least a spacer 4.

The frame set 2 substantially consists of a back plate 21, a frame 22 and a first macromolecule energy layer 23.

The back plate 21 of the frame set 2 can be made by one of fabric, paper wood or metal materials as one of the painting 1 main structure on which the painting set 3 the spacer 4 and the frame 22 are installed. In addition a front surface of the back plate 21 can be painted with a specific figure or texture in order to enhance a visual sensation.

The frame 22 of the frame set 2 is provided at a circumference of the back plate 21 by using either the same of different material of the back plate 21 in order to further enhance the visual sensation.

The first macromolecule energy layer 23 is provided at a front surface of the back plate 21 and includes a combination of substances having compositions of negative ion energy powders, which can emit negative ion energy beneficial to health with deodorizing and disinfecting effect, far infrared ceramic powders, which can emit far infrared radiation beneficial to health with deodorizing effect, activated carbon powders, which can deodorize and purify air with disinfecting effect, particles with titanium element, which has disinfecting effect, and germanium element, which can emit elements beneficial to health, nano silver particles, which has disinfecting effect, and titanium-oxide particles, which has disinfecting effect. By selecting substances having different compositions, it is able to provide the effects of absorbing unpleasant smells, disinfecting, deodorizing and so on in order to improve the air quality within a room environment as well as emitting far infrared radiation in order to enhance human health. The first macromolecule energy layer 23 can be manufactured in accordance with the material of the back plate 21, for instance, by adhesion, spray or dip, on the front surface of the back plate 21. In a preferred embodiment, the first macromolecule energy layer 23 is of a transparent, semi-transparent or glaring outlook in accordance with the painting 1 for achieving the integral visual sensation.

The painting set 3, as positioned adjacent to the front surface of the back plate 21 and separated from it, includes a main painting 31, a decorating edge 32 and a second macromolecule energy layer 33.

The main painting 31 of the painting set 3 is an artistic drawing creation with a specific figure or texture that is one of a painting on paper, painting on fabric, ceramic engraving or a painting on other materials in order to provide the visual sensation to people without any limitation on the materials, formats, geometries and sizes.

The decorating edge 32 of the painting set 3 is positioned at a circumference of the main painting 31 similar to the frame 22 for further enhancing the spiritual refinement. However, the circumference of the main painting 31 can also be without the decorating edge 32 in order to provide the other visual effect.

The second macromolecule energy layer 33 of the painting set 3 is provided at a rear surface of the main painting 31 adjacent to the first macromolecule energy layer 23 as separated from each other and includes the substances similar to the first macromolecule energy layer 23. Thereby both macromolecule energy layers are thus in coordination with each other in order to facilitate an air circulation within a room and emit the above-mentioned energy and radiation for achieving the optimal deodorizing and disinfecting effects.

The spacer 4 is securely provided between the frame set 2 and the painting set 3 so as to keep a specific distance between the frame set 2 and the painting set 3. Thereby a clearance between the first macromolecule energy layer 23 and the second macromolecule energy layer 33 is retained in order to facilitate the air circulation that the contaminated air within the room will be treated and purified when flowing through the first macromolecule energy layer 23 and the second macromolecule energy layer 33 so as to improve the environment quality of the room inside which the painting 1 stays. In the preferred embodiment the painting 1 is provided with four pieces of spacer 4 for illustrating purpose. The spacer 4 can be made of wood and symmetrically and evenly distributed between the frame set 2 and the painting set 3. However, the quantity, materials and locations of the spacer 4 can be adjusted upon demand without any specific limitation.

In summary, with the first macromolecule energy layer 23 and the second macromolecule energy layer 33 the painting 1 of the present invention can provide the effects of absorbing unpleasant smells, deodorizing and disinfecting in order to improve the air quality within a room as well as emit the negative ion energy and far infrared radiation in order to enhance human health. Thereby the painting 1 has addition of practical applications besides the artistic value. Further the painting 1 can be provided with more macromolecule energy layers at different locations upon demand for increasing the functionality of the painting 1.

I claim:

1. A painting with macromolecule energy layer comprising:
a frame set consisting of a back plate and a first macromolecule energy layer provided on a front surface of the back plate; and
a painting set, positioned adjacent to the front surface of the back plate, consisting of a main painting, provided with a specific figure or texture, and a second macromolecule energy layer, provided at a rear surface of the main painting as facing and separated from the first macromolecule energy layer.

2. The painting with macromolecule energy layer of claim 1, wherein the first and second macromolecule energy layers include a combination of substances having negative ion energy powders, far infrared ceramic powders, activated carbon powders, particles with titanium element and germanium element, nano silver particles and titanium oxide powders.

3. The painting with macromolecule energy layer of claim 1, wherein the main painting is one of a painting on paper, painting on fabric or ceramic engraving.

4. The painting with macromolecule energy layer of claim 1, wherein further includes at least a spacer that is securely provided between said frame set and said painting set so as to keep a specific distance between said frame set and said painting set.

5. The painting with macromolecule energy layer of claim 1, wherein further includes multiply spacers that are symmetrically and evenly distributed between said frame set and said painting set.
